(19) United States
(12) Patent Application Publication
(10) Pub. No.: US 2006/0034208 A1
(43) Pub. Date: Feb. 16, 2006

(54) Modified backoff mechanism for wireless networks

(76) Inventor: Francois Blouin, Hull (CA)

Correspondence Address: SMART AND BIGGAR, 438 UNIVERSITY AVENUE, SUITE 1500 BOX 111, TORONTO, ON, M5G2K8, CA

(21) Appl. No.: 10/914,365

(22) Filed: Aug. 10, 2004

(51) Int. Cl. H04Q 7/00; H04L 12/413

(52) U.S. Cl. 370/328; 370/445

(57) ABSTRACT

In a scheme for accessing a wireless network, a backoff delay time period representing a duration of time that is to elapse before a station is permitted to attempt a retransmission is selected from a group of delay periods. The group of delay periods grows at a rate that is less than exponentially (e.g. linearly) based on the number of attempted retransmissions. Selection of the backoff delay time period may entail random selection of an integer N from a contention window and multiplication of N by a slot time duration. The contention window may be a range of integers [0, W-1]. The contention window size W may be initialized to a predetermined minimum value upon a first attempted transmission and may be capped at a predetermined maximum value. Average backoff delay may be reduced in comparison to a binary exponential backoff approach.

### FIELD OF THE INVENTION

The present invention relates to network access mechanisms, and more particularly to network access mechanisms used to access wireless local area networks.

### BACKGROUND OF THE INVENTION

Wireless local area networks (LANs) have become ubiquitous in airports, coffee shops, enterprises and other locations in which wireless network access to data services is desirable. Many wireless LANs support the popular IEEE 802.11 standard for wireless LAN protocol, or one if its variants, such as 802.11a, 802.11b (“Wi Fi”), 802.11e, or 802.11g. The IEEE 802.11, 802.11a, 802.11b, 802.11e, and 802.11g standards are referred to herein as the “802.11 family of standards.”

In each standard comprising the 802.11 family of standards, synchronous data transmissions are governed by the Distributed Coordination Function (DCF). The DCF governs shared access to the wireless medium based on the Carrier Sense Multiple Access/Collision Avoidance (CSMA/CA) protocol. The basic idea of CSMA/CA is “listen before talk”: a station (i.e. a wireless network node) desirous of transmitting a message must probe the wireless medium before transmission to ensure that another station is not already transmitting.

The “listen before talk” collision avoidance approach differs from collision detection schemes such as the Carrier Sense Multiple Access/Collision Detection (CSMA/CD) scheme used with wired Ethernet. Collision detection schemes rely on the ability of a station to detect a collision (i.e. the simultaneous transmission by two or more stations on a medium) while the station is transmitting. Wireless stations are generally unable to detect collisions while transmitting, since a transmitting station's receiving antenna cannot hear any signal but the station's own transmitted signal. For this reason, the collision avoidance approach is used instead of the collision detection scheme is not suitable for use with wireless LANs.

According to the CSMA/CA scheme, a wireless station wishing to transmit a message (the “proposed transmitter”) must first sense the wireless medium to determine whether another station is transmitting. If the medium is sensed to be free for a specific time interval (the DCF Inter-Frame Space or “DIFS” interval), transmission of the message may proceed. If, on the other hand, the medium is busy with another station's transmission, transmission of the message must be deferred until after the other station's transmission is completed.

When the other station has finished its transmission, the proposed transmitter waits for an additional DIFS interval. When the DIFS time interval has elapsed, the proposed transmitter must then wait for a further “backoff delay” time period. The backoff delay time period is a random time interval that is intended to reduce the likelihood of collisions between multiple stations that are waiting for a busy wireless medium to become free in order to transmit. The backoff delay time period is determined by multiplying a “slot time” by a randomly chosen “backoff delay factor.” The slot time, which is typically in the range of 20 to 50 microseconds, represents the time necessary for a station to detect the transmission of a packet from any other station. The backoff delay factor is an integer representing the number of time slots that are to elapse under the CSMA/CA scheme before the station is permitted to sense the channel again in an attempt to retransmit. The backoff delay factor is chosen at random, and uniformly (i.e. with equal probability), from the range [0, W-1], which is referred to as the “contention window” or the “backoff window”. With is an integer representing the contention window size.

The technique that is typically used by a proposed transmitter to wait for the backoff delay time period is as follows. The first time that the station attempts to retransmit, the backoff window size W is set to a minimum value (denoted “CWmin”), which may for example be eight (8). A backoff delay factor is then chosen with equal probability from the range [0, W-1], which in the present example would be the set [0, 1, 2, 3, 4, 5, 6, 7]. A backoff timer is then set to a value representing the chosen backoff delay factor multiplied by the slot time, and countdown begins. The backoff timer is decreased as long as the medium is sensed to be idle. If a transmission is detected on the medium, the timer is frozen, however countdown is resumed when the medium is sensed to be idle again for more than a DIFS interval. Only when the backoff timer reaches zero is the station permitted to reattempt its transmission.

When the proposed transmitter attempts to retransmit, it is of course possible that the retransmission will not be possible because the medium has once again become busy. Alternatively, the retransmission may collide with another station's transmission (e.g., a third station which has grabbed the transmission medium ahead of the proposed transmitter). The proposed transmitter may become aware of the collision through a failure to receive an acknowledgement from the intended receiving station. In either case, the proposed transmitter is again forced to wait for a backoff delay time period. The backoff delay time period is again based on backoff delay factor chosen from the contention window, however, the size W of the contention window is doubled before the backoff delay factor is selected. In the previous example, W would accordingly be doubled to sixteen (16), and the backoff delay factor would be now be chosen uniformly from the set [0, 1, 2, 3, 4, 5, 6, 7, 8, 9, 10, 11, 12, 13, 14, 15].

The reason for doubling W is to provide a larger time window during which the retransmission may be made, such that the chance of collision with another station also attempting to retransmit will be reduced.

The process repeats as many times as necessary for the message to be transmitted. For each attempted retransmission, W is doubled before the backoff delay factor is chosen. W is typically capped at a maximum value (denoted “CWmax”), at which point no further doubling of W is performed even if one or more retransmissions are necessary. This approach for determining backoff delay is referred to as the “binary exponential backoff mechanism.”

Because the binary exponential backoff mechanism can result in exponential growth in backoff delay, transmission of voice and other real-time interactive communications that are sensitive to delay over a wireless LAN supporting an 802.11 family standard (or other wireless LAN standard using the binary exponential backoff mechanism) may yield sub-optimal performance. Significant delays may for example occur when the transfer of a large file by one station causes a relatively large amount of collisions and exponential backoff at other stations. Extended backoff delays tend to cause outgoing messages to become backlogged at a station, which may result in increased competition for the transmission medium between stations. As the number of stations connected to a wireless network increases, delays may be exacerbated due to the overall increase in volume of data communications. Delays may far exceed 150 milliseconds—a commonly recognized upper threshold for delay which can be tolerated in voice communications without significant reduction in quality.

An alternative approach for determining backoff delay for wireless LANs would be desirable.

### SUMMARY OF THE INVENTION

In a scheme for accessing a wireless network, a backoff delay time period representing a duration of time that is to elapse before a station is permitted to attempt a retransmission is selected from a group of delay periods. The group of delay periods grows at a rate that is less than exponentially (e.g. linearly) based on the number of attempted retransmissions. Selection of the backoff delay time period may entail random selection of an integer N from a contention window and multiplication of N by a slot time duration. The contention window may be a range of integers [0, W-1]. The contention window size W may be initialized to a predetermined minimum value upon a first attempted transmission and may be capped at a predetermined maximum value. Average backoff delay may be reduced in comparison to a binary exponential backoff approach.

In accordance with an aspect of the present invention there is provided a method of accessing a wireless network, comprising: for each of a plurality of attempted retransmissions: increasing the size of a group of delay periods such that the group grows at a rate that is less than exponentially with the number of attempted retransmissions; and selecting a delay period from the group of delay periods for use in scheduling a retransmission over the wireless network.

In accordance with another aspect of the present invention there is provided a computer-readable medium storing instructions which, when executed by a station in a wireless network, cause the station to: for each of a plurality of attempted retransmissions: increase the size of a group of delay periods such that the group grows at a rate that is less than exponentially with the number of attempted retransmissions; and select a delay period from the group of delay periods for use in scheduling a retransmission over the wireless network.

In accordance with yet another aspect of the present invention there is provided a station in a wireless network operable to access the network by: for each of a plurality of attempted retransmissions: increasing the size of a group of delay periods such that the group grows at a rate that is less than exponentially with the number of attempted retransmissions; and selecting a delay period from the group of delay periods for use in scheduling a retransmission over the wireless network.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate example embodiments of this invention:

FIG. 1 is a schematic diagram illustrating a wireless local area network; and

FIG. 2 illustrates operation for transmitting a message over the wireless local area network of FIG. 1.

### DETAILED DESCRIPTION

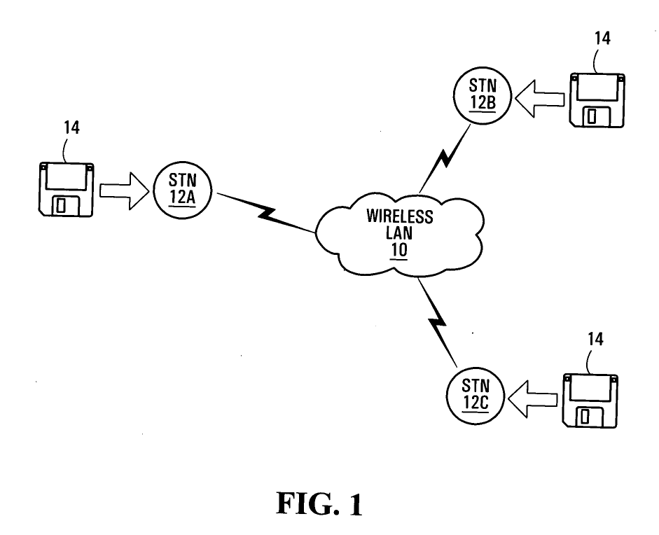

FIG. 1 illustrates a wireless local area network (LAN) 10 including a number of stations 12A, 12B and 12C (referred to generically and cumulatively as station(s) 12). The stations 12 may be portable computers, portable digital assistants, VLAN mobile (i.e. WLAN cordless) handsets or other computing devices which are capable of intercommunication over the common wireless medium provided by the LAN 10. The wireless LAN 10 in the present embodiment operates in accordance with a modified version the IEEE 802.11 protocol, as will be described.

Each station 12 in the wireless LAN 10 accesses the shared medium in accordance with a modified version of the Carrier Sense Multiple Access/Collision Avoidance (CSMA/CA) protocol. The modified CSMA/CA protocol is the same as the CSMA/CA protocol employed in the IEEE 802.11 standard, except that a different backoff delay mechanism is used. The CSMA/CA protocol may for example be executed by a LAN controller (not shown) in each station. Operation of the LAN controller may be controlled by software loaded from a computer readable medium, such as a removable magnetic or optical disk 14.

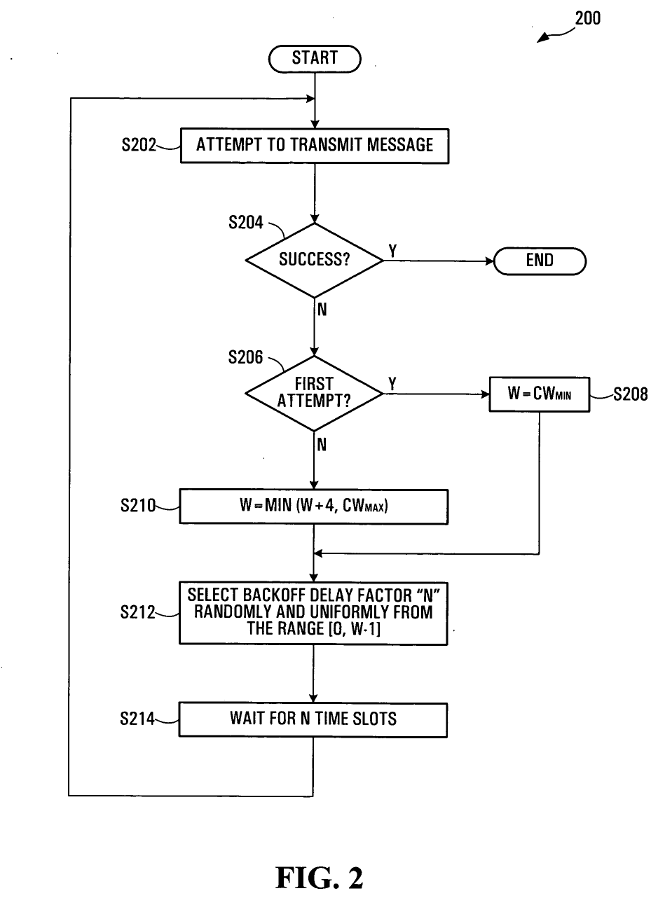

FIG. 2 illustrates operation 200 of a station 12 for transmitting a message over the wireless LAN 10. Operation 200 illustrates the backoff delay mechanism employed within the modified CSMA/CA protocol of the present embodiment.

Initially, the station 12 makes a first attempt to transmit the message (S202). This attempt entails sensing of the wireless medium to determine whether another station is transmitting. If the medium is sensed to be free for a DIFS interval, transmission of the message may proceed (S204), and, assuming that an acknowledgement indicative of successful transmission is received from the receiving station, operation 200 completes.

If, on the other hand, no acknowledgement is received from the intended receiver, or alternatively if the medium is found to be busy with another station's transmission such that no attempt to transmit the message could be made (S204), transmission must be deferred for a backoff delay time period.

Given that the attempt to transmit the message was the first attempt (S206), the backoff window size W is initially set to a minimum value “CWmin” (S208), which in the present example is eight. A backoff delay factor N is then selected at random, and uniformly (i.e. with equal probability), from the “contention window”, i.e. from is the range [0, W-1] (S212). In the present example, the backoff factor N is accordingly selected from the set [0, 1, 2, 3, 4, 5, 6, 7].

The backoff factor N is used for scheduling a next attempted retransmission, as follows. Assuming that the station 12 wishing to transmit has waited for the DIFS interval after sensing the medium to be free, the station 12 waits for the backoff delay time period consisting of N time slots (S214). Waiting may entail setting a backoff timer to a value representing the chosen backoff delay factor multiplied by the slot time and initiating timer countdown. The backoff timer may be decreased as long as the medium is sensed to be idle. If a transmission is detected on the medium, the timer may be frozen until the medium is sensed to be idle again for more than a DIFS interval, at which time countdown may be resumed.

When the backoff timer reaches zero, the station may reattempt its transmission (S202). The station 12 again senses the wireless medium to determine whether another station is transmitting. If the medium is sensed to be free for the DIFS interval, transmission of the message may proceed (S204), and, assuming that an acknowledgement is received to indicate successful reception of the message, operation 200 completes.

However, if no acknowledgement is received from the intended receiver, or alternatively if the medium was again busy with another station's transmission such that no attempt to retransmit the message could be made (S204), retransmission must again be deferred for another, newly determined backoff delay time period.

Because this was not the first attempt to transmit the message (S206), the contention window size W is increased by a fixed number of integers (i.e. the range is extended by a fixed amount) (S210). In the present example, W is increased by four, to twelve.

The backoff delay factor N is again selected at random and with equal probability from the range [0, W-1] (S212), which range now consists of the set [0, 1, 2, 3, 4, 5, 6, 7, 8, 9, 10, 11].

At this stage, after waiting for the DIFS interval, the station 12 waits for the newly selected backoff delay time period using the same approach (i.e. setting and starting a timer, freezing and restarting countdown upon sensing busy/free medium, etc.) as before (S214). When the waiting is complete, the station 12 reattempts transmission (S202).

Operation 200 repeats in this manner until the message is successfully transmitted. With each attempted retransmission, the contention window W is increased by four, until the window size reaches a predetermined maximum value “CWmax”, which in the present embodiment is fifty (S210). Once W reaches CWmax, it does not increase further even if one or more retransmission attempts are necessary.

As should now be apparent, because W grows by a fixed number (i.e. linearly) with each attempted retransmission, rather than exponentially as in the binary exponential backoff mechanism used by default by the 802.11 family of standards, the backoff delay time period that a station will be forced to wait before a message is successfully transmitted will, on average, be reduced. As a result, delays in transmission of voice and other real-time interactive communications that are sensitive to delay may be reduced, and improved performance of applications relying upon such communications may be enjoyed.

As will be appreciated by those skilled in the art, modifications to the above-described embodiments can be made without departing from the essence of the invention. For example, although the contention window size of the above-described embodiment is increased by four before each attempted retransmission, in alternative embodiments the contention window may be increased by other fixed amounts, such as by three or five for example. The only stipulation is that the amount should not be so large (e.g. 100) as to effectively defeat the purpose of the linear increase.

It is also possible for the contention window size to be increased by amounts which are not fixed, but which still approximate linear growth. For example, for a first attempted retransmission, the contention window size may be increased by four; for a second attempted retransmission, the contention window size may be increased by three; for a third attempted retransmission, the contention window size may be increased by four again; and so on. In this case, the growth of the contention window may not be strictly linear, however the growth is certainly less than exponential growth.

As well, it should be noted that the minimum contention window size (CWmin) and maximum contention window size (CWmax) may be set to values other than eight and fifty respectively, again with the caveat that the purpose of the linear increase should not be defeated.

In another alternative, the contention window, which is typically each integer in the range [0, W-1], may not be restricted to that range. For example, the contention window in alternative embodiments may instead include each integer in the range [1, W]. Alternatively, the contention window may not include each integer in the relevant range. Rather, certain integers may be skipped, e.g., [0, 1, 3, 4]. Of course, the use of such alternative contention windows may result in slightly longer average backoff delay time periods.

It is also noted that, while selection of a backoff delay factor from the contention window is normally performed uniformly, that is, with each integer in the range having an equal chance of selection, this is not necessarily the case in alternative embodiments.

Also, it will be appreciated that selection of a backoff delay time period as described above, i.e., through random selection of an integer N from a contention window and multiplication of N by a slot time, is but one manner of determining the backoff delay time period. The backoff delay time period may be determined in other ways. For instance, the backoff delay time period may be selected from a group of pre-computed delay periods. The specific method used is not important, so long as the backoff delay time period is effectively chosen from a group of delay periods which grows linearly based on the number of attempted retransmissions.

Finally, it should also be appreciated that, while the above embodiment is described within the context of a wireless LAN supporting one of the 802.11 family of standards, the same backoff delay mechanism may be used in other types of wireless networks. In principle, embodiments of the invention are applicable in virtually any form of media access control where a backoff/retransmission arbitration mechanism is employed.

Other modifications will be apparent to those skilled in the art and, therefore, the invention is defined in the claims.

What is claimed is:

1. A method of accessing a wireless network, comprising:
for each of a plurality of attempted retransmissions:
increasing the size of a group of delay periods such that said group grows at a rate that is less than exponentially with the number of attempted retransmissions; and
selecting a delay period from said group of delay periods for use in scheduling a retransmission over said wireless network.

2. The method of claim 1 wherein said increasing comprises increasing said group of delay periods by a fixed number of delay periods upon each attempted retransmission.

3. The method of claim 2 wherein said fixed number is four.

4. The method of claim 1 wherein each of said delay periods is an integer value, wherein said selecting a delay period results in a selected integer value, and wherein said scheduling a retransmission comprises delaying said retransmission for a time period equal to said selected integer value multiplied by a time slot duration.

5. The method of claim 4 wherein said group of integer values comprises a range of integers.

6. The method of claim 5 wherein said range of integers is from zero to W minus one inclusive, where W is a contention window size.

7. The method of claim 1 wherein said selecting a delay period comprises randomly and uniformly selecting said delay period from said group of delay periods.

8. The method of claim 1 further comprising setting said delay period to a predetermined minimum value upon a first attempt to transmit.

9. The method of claim 1 further comprising setting said delay period to a predetermined maximum value when the number of attempted retransmissions reaches or exceeds a threshold.

10. The method of claim 1 wherein said wireless network is a local area network.

11. The method of claim 1 wherein said wireless network conforms to an Institute of Electrical and Electronics Engineers (IEEE) standard selected from the group consisting of the IEEE 802.11, 802.11a, 802.11b, 802.11e, and 802.11g standards.

12. A computer-readable medium storing instructions which, when executed by a station in a wireless network, cause said station to:
for each of a plurality of attempted retransmissions:
increase the size of a group of delay periods such that said group grows at a rate that is less than exponentially with the number of attempted retransmissions; and
select a delay period from said group of delay periods for use in scheduling a retransmission over said wireless network.

13. The computer-readable medium of claim 12 wherein said increasing the size of said group of delay periods comprises increasing the size of said group of delay periods by a fixed number of delay periods upon each attempted retransmission.

14. The computer-readable medium of claim 13 wherein said fixed number is four.

15. The computer-readable medium of claim 12 wherein each of said delay periods is an integer value, wherein selecting a delay period results in a selected integer value, and wherein said scheduling a retransmission comprises delaying said retransmission for a time period equal to said selected integer value multiplied by a time slot duration.

16. The computer-readable medium of claim 15 wherein said group of integer values comprises a range of integers.

17. The computer-readable medium of claim 16 wherein said range of integers is from zero to W minus one inclusive, where W is a contention window size

18. The computer-readable medium of claim 12 wherein selecting a delay period comprises randomly and uniformly selecting said delay period from said group of delay periods.

19. The computer-readable medium of claim 12 wherein said instructions further cause said station to set said delay period to a predetermined minimum value upon a first attempt to transmit.

20. The computer-readable medium of claim 12 wherein said instructions further cause said station to set said delay period to a predetermined maximum value when the number of attempted retransmissions reaches or exceeds a threshold.

21. The computer-readable medium of claim 12 wherein said wireless network is a local area network.

22. The computer-readable medium of claim 12 wherein said wireless network conforms to an Institute of Electrical and Electronics Engineers (IEEE) standard selected from the group consisting of the IEEE 802.11, 802.11a, 802.11b, 802.11e, and 802.11g standards.

23. A station in a wireless network operable to access said network by:
for each of a plurality of attempted retransmissions:
increasing the size of a group of delay periods such that said group grows at a rate that is less than exponentially with the number of attempted retransmissions; and
selecting a delay period from said group of delay periods for use in scheduling a retransmission over said wireless network.

24. The station of claim 23 wherein said increasing comprises increasing said group of delay periods by a fixed number of delay periods upon each attempted retransmission.

25. The station of claim 24 wherein said fixed number is four.

26. The station of claim 23 wherein each of said delay periods is an integer value, wherein said selecting a delay period results in a selected integer value, and wherein said scheduling a retransmission comprises delaying said retransmission for a time period equal to said selected integer value multiplied by a time slot duration.

27. The station of claim 26 wherein said group of integer values comprises a range of integers.

28. The station of claim 27 wherein said range of integers is from zero to W minus one inclusive, where W is a contention window size.

29. The station of claim 23 wherein said selecting a delay period comprises randomly and uniformly selecting said delay period from said group of delay periods.

30. The station of claim 23 further operable to set said delay period to a predetermined minimum value upon a first attempt to transmit.

31. The station of claim 23 further operable to set said delay period to a predetermined maximum value when the number of attempted retransmissions reaches or exceeds a threshold.

32. The station of claim 23 wherein said wireless network is a local area network.

33. The station of claim 23 wherein said wireless network conforms to an Institute of Electrical and Electronics Engineers (IEEE) standard selected from the group consisting of the IEEE 802.11, 802.11a, 802.11b, 802.11e, and 802.11g standards.
